(19) United States
(12) Patent Application Publication
(10) Pub. No.: US 2015/0271546 A1
(43) Pub. Date: Sep. 24, 2015

(54) SYNCHRONIZED PROVISION OF SOCIAL MEDIA CONTENT WITH TIME-DELAYED VIDEO PROGRAM EVENTS

(71) Applicant: SLING MEDIA INC., Foster City, CA (US)

(72) Inventor: James Chihoon Kim, Redwood City, CA (US)

(21) Appl. No.: 14/221,112

(22) Filed: Mar. 20, 2014

(51) Int. Cl. H04N 21/43; G06F 17/30; H04N 21/8547; H04N 21/262; H04N 21/4788

(52) U.S. Cl. CPC H04N 21/4307; H04N 21/2625; H04N 21/4788; H04N 21/8547; G06F 17/30864; G06F 17/30997

(57) ABSTRACT

Systems and related operating methods of providing social media content in conjunction with the presentation of video content are presented here. In accordance with one exemplary operating method, a time-delayed version of a video program event is provided for presentation on a display. The method also obtains social media messages that reference the video program event, and temporally synchronizes the obtained social media messages with the time-delayed version of the video program event, resulting in a synchronized stream of social media content. The method continues by delivering the synchronized stream of social media content concurrently with presentation of the time-delayed version of the video program event.

### TECHNICAL FIELD

Embodiments of the subject matter described herein relate generally to video delivery systems. More particularly, embodiments of the subject matter relate to the synchronized delivery of social media messages that relate to a time-delayed video program event.

### BACKGROUND

Most television viewers now receive their video signals through a content aggregator such as a cable or satellite television provider. Digital video broadcasting (DVB) systems, such as satellite systems, are generally known. A DVB system that delivers video service to a home will usually include a video services receiver, system, or device, which is commonly known as a set-top box (STB). In the typical instance, encoded television signals are sent via a cable or wireless data link to the viewer's home, where the signals are ultimately decoded in the STB. The decoded signals can then be viewed on a television or other appropriate display as desired by the viewer.

Time-shifting technologies allow a user to delay the presentation of a broadcast or live video program event, such that a time-delayed version of the program event can be viewed at a convenient time. Such time-shifting technologies include digital video recording, buffering, and the like. For example, a user might record a broadcast television show for viewing at any time in the future. As another example, a user might buffer a live sporting event to introduce a slight delay (e.g., 30 minutes) such that the user can quickly skip commercials, timeouts, halftime activities, etc.

Social media services and applications allow participants to create and publish messages, posts, and commentary in real-time or in virtually real-time. Moreover, social media services and applications may allow video networks, content providers, program events, and fictional characters that appear in program events to join the social networks as participants. For example, THE HISTORY CHANNEL could be a user of a social media platform such as FACEBOOK, TWITTER, or INSTAGRAM. Similarly, a recurring show or program, such as THE BIG BANG THEORY could have a TWITTER, FACEBOOK, and/or INSTAGRAM account. Likewise, a special event, such as THE GRAMMY AWARDS or THE SUPER BOWL, may have an associated TWITTER, FACEBOOK, and/or INSTAGRAM account that is only active for a limited period of time that surrounds the actual event date. These and other types of social media accounts can be used for marketing, advertising, public relations, and “fan interaction” purposes. For example, the social media handle “Super Bowl XLIX” could be established to allow football fans and commentators to publish social media messages related to the Super Bowl XLIX game or broadcast by including that particular handle in the message content. Thus, other users interested in commentary or messages related to the Super Bowl XLIX event can “follow” the Super Bowl XLIX account to receive related messages.

Social media messages (which are published in real-time or virtually real-time immediately after they are created) referring to a particular video program event will be synchronized in time with the video content if the event is a live broadcast event, e.g., a live sporting event, a live concert, the original or initial broadcast of a network program, a live awards ceremony, a live newscast, or the like. In contrast, social media messages referring to a particular video program event will be “offset” in time if the event is presented in a time-delayed manner. As a result, social media messages can act as “spoilers” that disclose the content of time-delayed programming. For example, if an awards ceremony is recorded and played back a few hours after its scheduled start time, then social media users may already be discussing the winners before the user decides to watch the recorded content. As another example, if a viewer decides to delay a live sporting event by 30 minutes, then the related social media commentary might prematurely reveal the score and/or important game milestones.

Accordingly, it is desirable to have a system and methodology that addresses the above-mentioned shortcomings of real-time delivery of social media messages. In addition, it is desirable to have a system and methodology for temporally synchronizing social media messages with time-delayed presentation of video program events. Furthermore, other desirable features and characteristics will become apparent from the subsequent detailed description and the appended claims, taken in conjunction with the accompanying drawings and the foregoing technical field and background.

### BRIEF SUMMARY

Exemplary embodiments of a method of providing social media content in conjunction with the presentation of video content are presented herein. In accordance with one embodiment, the method provides providing a time-delayed version of a video program event for presentation. The method also obtains social media messages that reference the video program event, and temporally synchronizes the obtained social media messages with the time-delayed version of the video program event, resulting in a synchronized stream of social media content. The method continues by delivering the synchronized stream of social media content concurrently with presentation of the time-delayed version of the video program event.

Another exemplary embodiment of the method accesses a database of social media messages, searches the database of social media messages to identify program-related social media messages that reference a video program event, and analyzes time stamp information of the program-related social media messages to identify time-related social media messages having message publication times that occurred during an original presentation of the video program event. The method continues by providing a time-delayed version of the video program event for presentation, and delivering a synchronized stream of the time-related social media messages concurrently with presentation of the time-delayed version of the video program event. The timing of the synchronized stream is influenced by presentation timing of the time-delayed version of the video program event.

Also presented here is an exemplary embodiment of a video presentation system. The system includes: a receiver interface to receive data associated with video services; a display interface for a display operatively coupled to the video presentation system, the display interface facilitating presentation of content on the display; and a processor coupled to the receiver interface and the display interface. The processor cooperates with the receiver interface and the display interface to provide a time-delayed version of a video program event for presentation on the display, and to deliver a synchronized stream of time-delayed social media messages concurrently with presentation of the time-delayed version of the video program event. Each of the time-delayed social media messages identifies the video program event in some fashion. The timing of the synchronized stream is influenced by presentation timing of the time-delayed version of the video program event.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram that illustrates an exemplary embodiment of a video delivery system;

FIG. 2 is diagram that schematically represents relative timing of a live broadcast of a video program event, real-time social media messages associated with the live broadcast, and a time-delayed version of the video program event;

FIG. 3 is a diagram that schematically represents relative timing of a live broadcast of a video program event, a time-delayed version of the video program event, and a temporally synchronized stream of social media messages associated with the video program event; and

FIG. 4 is a flow chart that illustrates an exemplary embodiment of a process for providing synchronized social media content in conjunction with a time-delayed presentation of video content.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like. The software that performs the described functionality may reside and execute at a host device, such as a video services receiver, a mobile device, or a home entertainment component, or it may be distributed for execution across a plurality of physically distinct devices, systems, or components, as appropriate for the particular embodiment.

The following description relates to a video delivery system that is suitably configured to process audio/visual content for presentation to a user. Although the following description focuses on video content conveyed in a video stream, the subject matter may also be utilized to handle audio content conveyed in an audio stream, such as a broadcast radio program, a streaming music channel, or the like.

The exemplary embodiments described below relate to a video delivery system such as a satellite television system, a cable delivery system, an Internet-based streaming content delivery system, a cellular network delivery system, or the like. The disclosed subject matter relates to a system and related methodology for providing program-related social media content (e.g., “tweets” or text messages from the TWITTER social media platform, posts from the FACEBOOK platform, picture messages from the INSTAGRAM platform, etc.) in a temporally synchronized manner relative to a time-delayed presentation of video programming, wherein the synchronized social media messages refer to the time-delayed program. Thus, the viewer can enjoy a time-shifted video program event while reading social media content that has also been delayed to preserve the “live experience” without introducing “spoilers” during the delayed presentation.

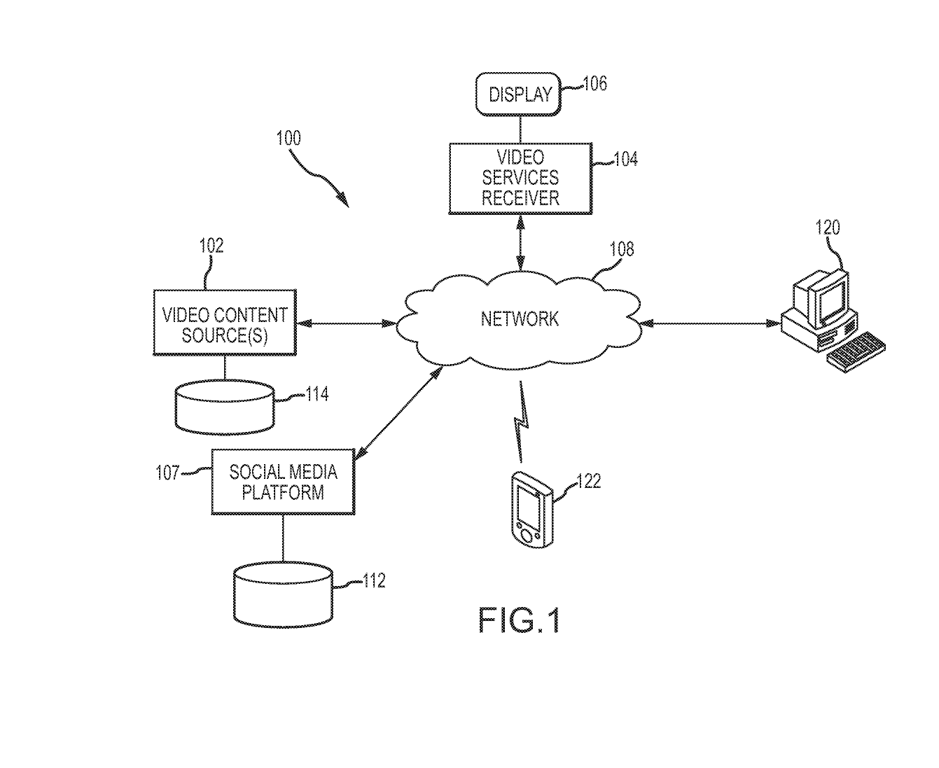

FIG. 1 is a block diagram that illustrates an exemplary embodiment of a video delivery system 100 that is suitably configured to support the techniques and methodologies described in more detail below. The system 100 (which has been simplified for purposes of illustration) generally includes, without limitation: at least one video content source 102 (referred to in the singular form herein for the sake of convenience); a video services receiver 104 or other form of customer equipment that is capable of receiving, processing, and rendering video content; a display 106 operatively coupled to the video services receiver 104; and a social media platform 107 (which may be realized using any suitable system configuration or architecture, which may include one or more distributed or co-located components). In certain embodiments, the video content source 102, the video services receiver 104, and the social media platform 107 communicate using a data communication network 108. For the sake of brevity, conventional techniques related to satellite, cable, and Internet-based communication systems, video broadcasting systems, data transmission, signaling, network control, and other functional aspects of the systems (and the individual operating components of the systems) may not be described in detail herein.

The data communication network 108 is any digital or other communications network capable of transmitting messages between senders (e.g., the video content source 102 or the social media platform 107) and receivers (e.g., the video services receiver 104). In various embodiments, the network 108 includes any number of public or private data connections, links or networks supporting any number of communications protocols. The network 108 may include the Internet, for example, or any other network based upon TCP/IP or other conventional protocols. In various embodiments, the network 108 also incorporates a wireless and/or wired telephone network, such as a cellular communications network for communicating with mobile phones, personal digital assistants, and/or the like. The network 108 may also incorporate any sort of wireless or wired local area networks, such as one or more IEEE 802.3 and/or IEEE 802.11 networks.

The system 100 may include or cooperate with any number of video content sources 102; FIG. 1 and this description refer to only one video content source 102 for the sake of simplicity. Moreover, a given video services provider (e.g., a satellite video provider, a cable television provider, a telecommunication services provider, or the like) could maintain, provide, or otherwise cooperate with any number of video content sources 102 designed to support any number of subscribers.

In certain embodiments, the video content source 102 may be deployed as a head end facility and/or a satellite uplink facility for the system 100. In some embodiments, the video content source 102 may include or cooperate with one or more web-based content delivery applications, services, or providers. The video content source 102 generally functions to control content, signaling data, programming information, and other data sent to any number of receiving components. In practice, the video content source 102 may also provide content and data that can be used to populate an interactive electronic program guide (EPG) generated by the video services receiver 104.

The video content source 102 includes one or more data processing systems or architectures that are capable of producing signals that are transmitted to customer premise equipment, mobile devices, computer systems, or the like. In various embodiments, the video content source 102 represents a satellite, cable, or other content distribution center having: a data control system for controlling content, signaling information, blackout information, programming information, and other data; and a control system for transmitting content, signaling information, blackout information, programming information, and other data using high-bandwidth links. These systems may be geographically, physically and/or logically arranged in any manner, with data control and uplink control being combined or separated as desired.

The video services receiver 104 represents one exemplary embodiment of a video presentation system, device, component, or module that is suitable for use in the system 100. The video services receiver 104 can be realized as any device, system or logic capable of receiving signals from a video content source 102. Accordingly, the video services receiver 104 may include a receiver interface to receive data associated with video services, including any number of video events that are provided by various video providers. As described in more detail below, the receiver interface may also be utilized to access and receive social media content (e.g., messages, posts, content feeds, information streams, and the like) from one or more social media platforms 107. In this regard, the video services receiver 104 may include or cooperate with a web browser application that provides access to various Internet-based services and resources, including social media applications, streaming media websites, audio/video content providers, and the like.

To support traditional video delivery functions, the video services receiver 104 is capable of providing demodulated content to a customer via the display 106. Accordingly, the video services receiver 104 may include a suitable display interface for the display 106, where the display interface facilitates presentation of video and image content on the display 106. As explained in more detail below with reference to certain exemplary embodiments, the video services receiver 104 may also be configured to obtain, process, and display social media messages on the display 106 at appropriate times, wherein the social media messages are relevant to the video program content, and wherein the timing of the social media messages is synchronized with time-delayed playback of video program events.

The display 106 may be realized as any of the following, without limitation: a television set; a monitor; a computer display; or any suitable customer appliance with compatible display capabilities. In various embodiments, the video services receiver 104 is implemented as a set-top box (STB) as commonly used with digital video broadcasting, satellite, or cable television distribution systems. In other embodiments, however, the functionality of the video services receiver 104 may be commonly housed within the display 106 itself. In still other embodiments, the video services receiver 104 is a portable device that may be transportable with or without the display 106. The video services receiver 104 may also be suitably configured to support broadcast television reception, video game playing, personal video recording and/or other features as desired.

During typical operation, the video services receiver 104 receives programming (broadcast events, on-demand video events, streaming media, emergency broadcasts, etc.), signaling information, and/or other data via the network 108. The video services receiver 104 then demodulates, decompresses, descrambles, and/or otherwise processes the received digital data, and then converts the received data to suitably formatted video signals that can be rendered for viewing by the customer on the display 106. The video services receiver 104 may also be capable of receiving web-based content via the network 108, the Internet, etc., and may also be capable of recording and playing back video content. In certain scenarios, the video services receiver 104 can be utilized as a playback system for digital media files (e.g., streaming media content) that convey recorded versions of original video program events. For example, an end user device could be used to download and present a video clip posted on the Internet (e.g., using the well-known YOUTUBE video sharing service), where the video clip is a recorded version of a show that has already been broadcast.

The social media platform 107 represents the hardware, software, processing logic, and architecture associated with one or more social media websites, services, applications, and/or providers. FIG. 1 depicts the social media platform 107 in a simplified manner for ease of description and illustration. In practice, the system 100 may include or cooperate with any number of different social media platforms 107 as needed or desired. For example, one social media platform 107 may be associated with the TWITTER social media service, another social media platform 107 may be associated with the INSTAGRAM social media service, etc.

The social media platform 107 includes or cooperates with a suitably configured database system 112 that maintains, organizes, and provides data used in association with the social media platform 107. In this regard, the data maintained by the database system 112 may include any type of social media content, information, and/or metadata. For example, the database system 112 may store social media messages that are published by the social media platform 107. As used here, “social media messages” may include any or all of the following items, without limitation: text messages; short message service (SMS) items; picture messages; video clip messages; social network posts; social network comments; comment threads; and the like. In certain non-limiting embodiments, the social media platform 107 corresponds to the TWITTER social media service, and the database system 112 is suitably configured to store user messages generated by the TWITTER service (i.e., “tweets”). In this regard, the social media platform 107 can maintain and provide access to one or more feeds that include the social media messages of interest. For this particular example, a TWITTER feed (often referred to as the TWITTER “fire hose”) may be accessible to one or more devices operating within the system 100.

At least some of the social media message data maintained by the database system 112 could be accessed, downloaded, or maintained by the video content source 102. Accordingly, FIG. 1 depicts an optional database system 114 operatively coupled to the video content source 102. This database system 114 could be used to store social media messages, which in turn can be provided to user presentation devices as needed. In practice, the entire set of social media messages need not be maintained by the database system 114. Rather, the video content source 102 and/or the database system 114 may be controlled and managed to disregard social media messages that are unrelated to the video program events provided by the video content source 102. Although not shown in FIG. 1, the video services receiver 104 may also include or cooperate with a database system to store and provide access to social media messages.

Although not separately depicted in FIG. 1, the video services receiver 104, the video content source 102, and/or another component in the system 100 may include video place-shifting functionality, or it may cooperate with a suitably configured place-shifting device or component to place-shift video content. In this regard, it may be possible to provide live or recorded content to a remote device operated by the user, wherein the video services receiver 104, the video content source 102, and/or another component in the system 100 serves as a source of the place-shifted content.

Although not required, the system 100 may support additional video presentation devices that enable the viewer to enjoy video programming at different locations. In this regard, the video services receiver 104 may be considered to be a primary video delivery device, especially if it is realized as a conventional STB that is connected to a monitor or television set in the user's home. The user may also own or operate a computing device 120 that is configured to receive and present video content. The user may also own or operate a mobile device 122 that is configured to receive and present video content. The computing device 120 may be realized using any compatible platform, including, without limitation: a desktop computer; a laptop computer; a tablet computer; a smart television device; a video game console; or any suitably configured piece of electronic equipment. The mobile device 122 may be realized using any compatible platform, including, without limitation: a smartphone; a digital media player; a handheld navigation device; a portable medical device; a smart wristwatch or other wearable computing device; or the like. These additional presentation devices may also cooperate with the social media platform 107 to access and provide social media messages to the user. For example, the video services receiver 104 could be operated to present a video program event to the user, and the computing device 120 and/or the mobile device 122 could be operated to concurrently present social media messages (that relate to the video program event) to the same user. As another example, the mobile device 122 could be operated to present the video program event and related social media messages to the user in a concurrent or simultaneous manner (e.g., using a split screen, a pop-up window, or alternating application screens).

It should be appreciated that the computing device 120, the mobile device 122, and/or other devices operating in the system 100 may include or cooperate with a database system that maintains some or all of the social media messages of interest (as described above with reference to the database system 112). In typical many scenarios, however, a remote device will simply tap into the social media message feeds provided by the social media service providers. For example, a user device may include a suitably written and formatted application that enables the user device to access a database of social media messages that is maintained by a third party.

Moreover, the computing device 120, the mobile device 122, and/or other devices operating in the system 100 may include any number of native video processing and rendering features and functions. In this regard, the computing device 120, the mobile device 122, and/or other devices in the system 100 can be suitably configured to perform the video presentation functions described in more detail herein.

The video services receiver 104, the computing device 120, and the mobile device 122 (along with any other video presentation device that supports the methodology described herein) can be implemented as (or can be integrated with) an electronic processor-based component. Regardless of its form factor and hardware platform, a video presentation device or system as described herein is suitably configured to support the desired features and functions using the appropriate hardware, software, firmware, etc. For example, the video services receiver 104 may include, without limitation: an input module or interface to receive video streams from the video content source 102; a network communication module to interface with the data communication network 108; device-specific hardware, software, firmware, and/or applications; at least one processor; and at least one memory element having a suitable amount of storage capacity. These elements cooperate to perform the various processes and methods described in more detail below.

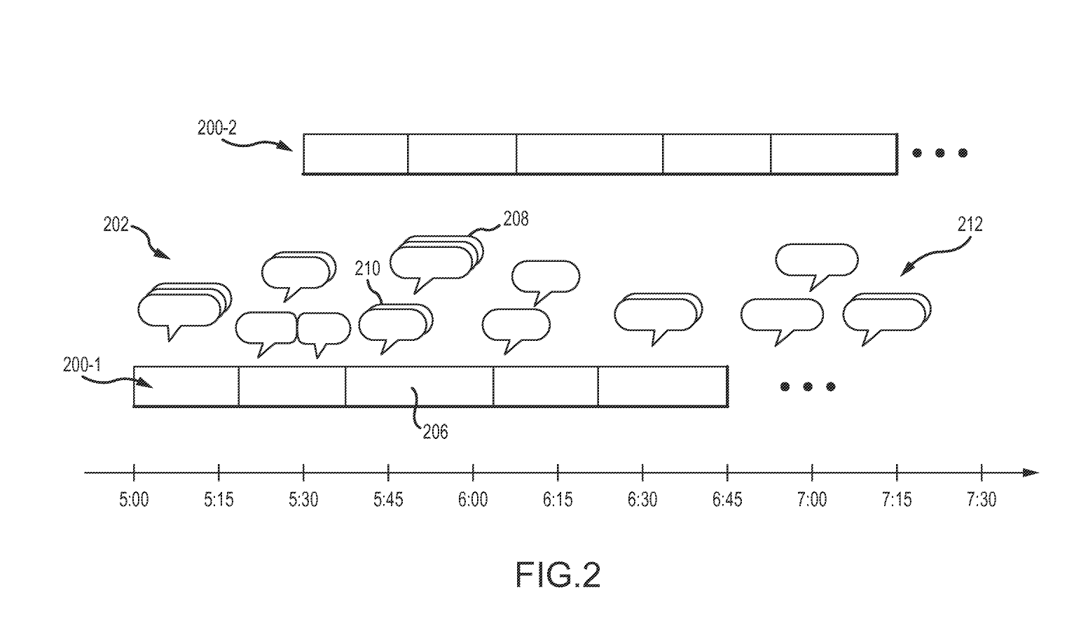

The system 100 is capable of presenting a synchronized stream of social media messages in concert with a time-delayed video program event, such that the social media messages are presented to the user in a manner that emulates the actual real-time publication of the messages. In this context, FIG. 2 is diagram that schematically represents relative timing of a live broadcast of a video program event 200-1, real-time social media messages 202 associated with the live broadcast, and a time-delayed version of the video program event 200-2. For this example, assume that the video program event 200 is a basketball game (the video program event 200 is depicted in five segments that correspond to the four periods of the game and a halftime period in the middle of the game). The original live broadcast of the basketball game begins at 5:00 PM local time, i.e., the time zone of the viewer/user, and ends at 6:45 PM local time.

FIG. 2 depicts the timing of social media messages 202 that refer to the basketball game. The social media messages 202 may include the hashtag of the video program event 200 (e.g., “#NBAPlayoffBasketball”), an “at-mention” of a social handle that is associated with the video program event 200 (e.g., @NBABasketball), or any other type of reference that links the social media messages 202 to the video program event 200. As shown in FIG. 2, social media messages 202 can be created and published in real-time during the original presentation of the video program event 200-1. Thus, a person watching the original live presentation of the video program event 200-1 can read the relevant social media messages 202 while remaining cognizant of the current time context. For example, during the halftime period 206 of the video program event 200-1, a number of social media messages 208, 210 may discuss the halftime score, statistics, memorable plays that occurred during the third period, etc. As another example, some social media messages 212 may be published after the video program event 200-1 has ended; these messages 212 may include a discussion of the final score, the top performers, etc.

The time-delayed version of the video program event 200-2 may be a local copy that has been recorded by the end user, an on-demand copy that is stored and maintained at a server associated with the video services provider, or the like. As another example, the time-delayed version of the video program event 200-2 may be a recorded version of an original presentation of a video program event that has been converted into a streaming media format, such that the time-delayed version of the video program event 200-2 can be presented to the end user via a web page, an Internet-based content provider, or the like.

The time-delayed version of the video program event 200-2 is shifted in time by approximately 30 minutes. Accordingly, the delayed video program event 200-2 begins during the second period of the basketball game, i.e., while the live version of the video program event 200-1 is still ongoing. For this example, the social media messages 208, 210 are temporally offset (they are premature) relative to the presentation time scale of the delayed video program event 200-2. Thus, a viewer of the time-delayed version of the video program event 200-2 could read social media messages 208, 210 that discuss the halftime score even though that viewer is still experiencing the first half action. Consequently, the real-time stream of social media messages 202 may serve as “spoilers” to viewers of the time-delayed version of the video program event 200-2.

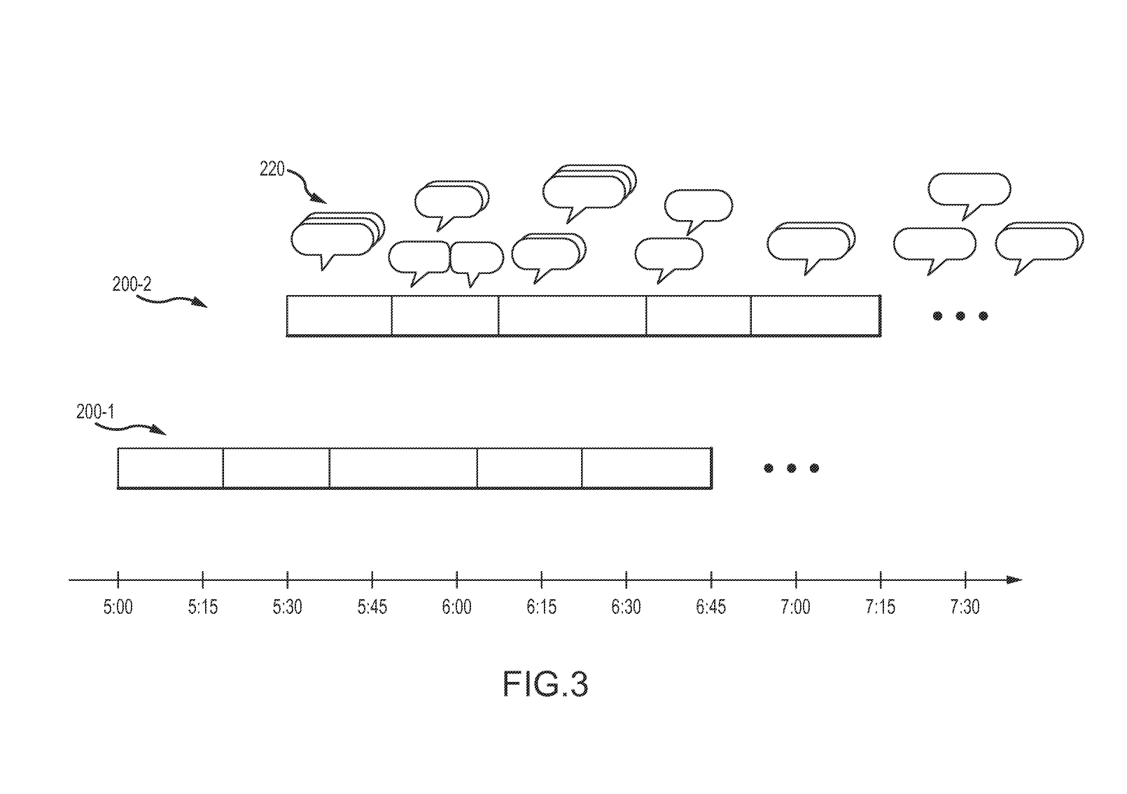

The techniques and technology described here address the “spoiler” scenario illustrated in FIG. 2 by delaying contextually relevant social media messages in accordance with the timing of a delayed video program event. FIG. 3 is a diagram that schematically represents relative timing of the live broadcast of the video program event 200-1, the time-delayed version of the video program event 200-2, and a temporally synchronized stream of social media messages 220 associated with the video program event 200. Conceptually, the stream of social media messages 220 have been time-delayed to temporally align them with the time-delayed presentation of the video program event 200-2. Accordingly, a viewer of the time-delayed video program event 200-2 can experience the social media messages 220 as though they are being published in real-time (relative to the presentation timing of the video program event 200-2).

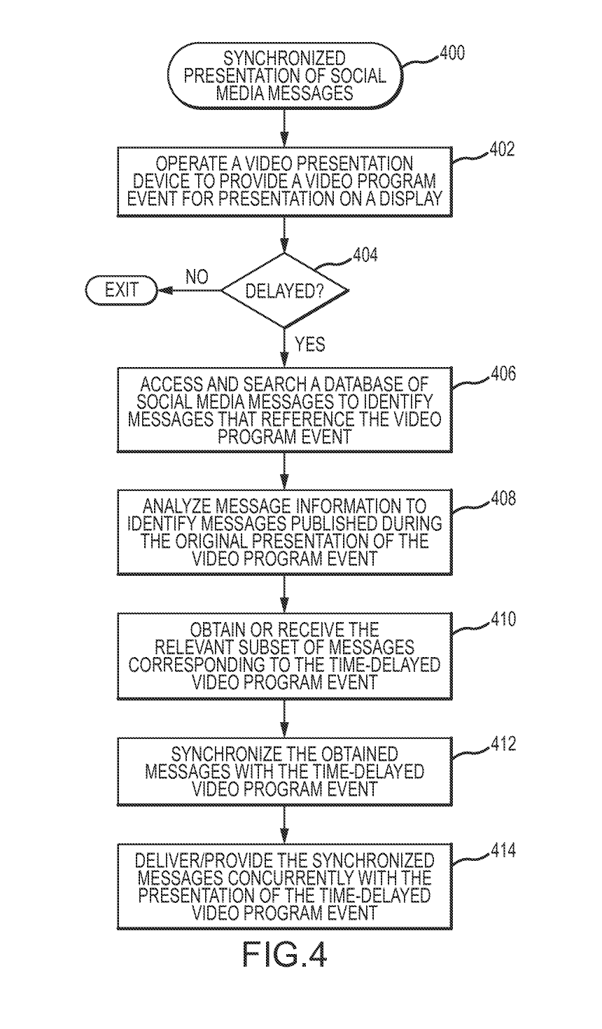

FIG. 4 is a flow chart that illustrates an exemplary embodiment of a process 400 for providing synchronized social media content in conjunction with a time-delayed presentation of video content. The various tasks performed in connection with the process 400 may be performed by software, hardware, firmware, or any combination thereof. For illustrative purposes, the following description of the process 400 may refer to elements mentioned above in connection with FIGS. 1-3. In practice, portions of the process 400 may be performed by different elements of the described system, e.g., a social media platform, a video services receiver, a presentation device, or a processing module of a computing device. It should be appreciated that the process 400 may include any number of additional or alternative tasks, the tasks shown in FIG. 4 need not be performed in the illustrated order, and the process 400 may be incorporated into a more comprehensive procedure or process having additional functionality not described in detail herein. Moreover, one or more of the tasks shown in FIG. 4 could be omitted from an embodiment of the process 400 as long as the intended overall functionality remains intact.

For this example, a video presentation device (e.g., a video services receiver) is operated to provide a video program event for presentation on a display (task 402). The process 400 may check whether the video program event is time-delayed (query task 404). In practice, the process 400 could utilize any appropriate technique or methodology to ascertain whether or not the video program event is time-delayed. In this regard, query task 404 could be performed locally by the video presentation device or by one or more backend system components, such as a video content source or a server-based processing component. If query task 404 is performed locally, then the presentation device may have prior knowledge of the playback status, i.e., whether the video program event is a recorded event, a buffered event, an ongoing live broadcast, or the like. If query task 404 is not performed locally, then the process 400 could analyze metadata or signaling data associated with the video program event and/or leverage automatic content recognition (ACR) techniques to determine whether the video program event corresponds to a scheduled event that is currently being broadcast.

If the video program event is an original live broadcast (the “No” branch of query task 404), then the process 400 may exit such that the video program event can be presented as usual. This description assumes that the process 400 determines that the video program event is time-delayed or is otherwise notified of the time-delayed status (the “Yes” branch of query task 404). Accordingly, the presentation device is provided with a time-delayed version of the video program event for presentation to the user. The process 400 may continue by accessing and searching one or more databases (task 406) that contain social media messages, e.g., the database system 112 or the database system 114. The searching associated with task 406 may be performed locally by the video presentation device and/or by the user device that provides the social media messages. In other implementations, the searching associated with task 406 may be performed by one or more backend system components, e.g., a server operated by the video services provider, a server operated by a social media service provider, a network-based system or component that is dedicated to the processing and analysis of social media messages, or the like. In some embodiments, the searching associated with task 406 could be performed in a distributed manner using any number of devices, components, or systems as appropriate to the particular implementation.

In certain embodiments, task 406 searches a database of social media messages to identify program-related messages that reference or identify the currently-playing time-delayed video program event. In this regard, video program events can be uniquely identified by social media handles, which may identify the program event title, the name of an episode, the name of a program series, the title of a special event, the broadcast network call letters, or the like. The social media handle of a video program event represents the “user name” of that particular event within the context of a social media network, application, or service. Thus, the same video program event may have different social media handles associated with different social media platforms (for example, a TWITTER handle and a different INSTAGRAM handle), or it may have a common social media handle that is used across different social media platforms.

In accordance with some embodiments, the process 400 searches the database of social media messages to obtain messages that include a social media handle of the video program event. For example, task 406 may identify social media messages that contain the hashtag #SuperBowlXLIX, and/or social media messages that contain a relevant at-mention, such as @SuperBowlXLIX. This aspect of the process 400 effectively filters the available set of social media messages to focus on those that might have some relevance to the time-delayed video program event. The process 400 may also analyze message information or metadata to identify the social media messages that were published during the original live presentation of the video program event (task 408). In practice, task 408 may analyze time stamp information of the social media messages to determine which messages were originally created/published during the non-delayed broadcast of the video program event. Task 408 may also identify social media messages that were published within a designated period of time before the original start time and/or within a designated period of time after the original end time of the video event. Thus, the process identifies time-related social media messages having message publication times that occurred during the original non-delayed presentation of the video program event. In accordance with some embodiments, the social media messages can be further filtered or screened for contextual relevance, popularity, or other factors if so desired.

The process 400 may continue by obtaining or receiving a relevant subset of social media messages corresponding to the time-delayed video program event (task 410). In this regard, task 406 and task 408 combine to filter the available population of social media messages according to both the social media handle of the program event and the original presentation time of the program event. Depending upon the specific implementation and deployment arrangement of the system, task 410 may involve the communication of the identified subset of messages to the user's presentation device or to a video services receiver. In alternative embodiments, task 410 may be performed locally by the presentation device itself (if the device includes or has local access to the database of social media messages).

The identified subset of social media messages are synchronized (in time) with the timing of the delayed video program event (task 412), as illustrated in FIG. 3. The temporal synchronization may be performed in accordance with the time stamp information of the social media message, the original presentation time of the video program event, timing data embedded in the delayed video stream, the scheduled start/end times of the video program event, local time zone information, etc. The temporally aligned stream of social media messages can then be delivered and provided to one or more user devices (e.g., a presentation device) concurrently with the presentation of the time-delayed video program event (task 414). As mentioned previously, the timing of the synchronized stream of social media messages is influenced by the presentation timing of the delayed version of the video program event. Thus, if the viewer fast-forwards or skips ahead in a recorded video program, the corresponding social media messages will be presented in a synchronized manner, preserving the relative timing relationship.

The social media messages and the time-delayed video program content may be displayed using the same presentation device, or on different devices. For example, the time-delayed video program can be provided by a set-top box while the delayed social media messages are concurrently displayed on the user's laptop computer or smartphone device. As another example, the synchronized social media messages could be displayed in a sidebar element or popup window of a display, while the majority of the display is devoted to the presentation of the time-delayed video program event.

It should be appreciated that the techniques and approaches described above can be applied to recorded or buffered video content such that delayed playback of the recorded content can be synchronized with relevant social media content. Moreover, the techniques and approaches described above can also be utilized to minimize social media “spoilers” associated with the broadcast of new video program events in different time zones. For example, the first broadcast of a new episode of a popular prime time show might occur at 8:00 PM Eastern Standard Time. The same episode may be re-broadcast at 8:00 PM Pacific Standard Time (three hours after the start time of the initial broadcast). In this scenario, the re-broadcast of the show can be treated as a time-delayed video program event, relative to the first broadcast that occurred in the Eastern Standard Time zone. Accordingly, the system described here may be suitably configured to consider any applicable time zone (e.g., the local time zone in which the presentation device is operating, the time zone in which the video program event was initially broadcast, and the time zones associated with the source of the related social media messages) when synchronizing the social media messages.

To summarize, the methodology described above can be utilized to temporally synchronize social media content (e.g., text messages, posts, picture messages, and SMS messages) with time-delayed video content. Temporal synchronization of the social media messages allows the viewer to enjoy the delayed video content while reviewing “timely” social media messages that might address the video content.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of providing social media content in conjunction with the presentation of video content, the method comprising:
providing a time-delayed version of a video program event for presentation;
obtaining social media messages that reference the video program event;
temporally synchronizing the obtained social media messages with the time-delayed version of the video program event, resulting in a synchronized stream of social media content; and
delivering the synchronized stream of social media content concurrently with presentation of the time-delayed version of the video program event.

2. The method of claim 1, wherein:
the video program event is identified by a social media handle; and
the obtaining step comprises:
accessing a database of social media messages; and
searching the database of social media messages to obtain social media messages that include the social media handle of the video program event.

3. The method of claim 2, wherein the social media handle comprises a hashtag of the video program event.

4. The method of claim 2, wherein the social media handle comprises an at-mention of the video program event.

5. The method of claim 1, wherein:
each of the obtained social media messages includes respective time stamp information that indicates a message publication time; and
the synchronizing step synchronizes the obtained social media messages in accordance with the time stamp information.

6. The method of claim 5, wherein the synchronizing step synchronizes the message publication time of the obtained social media messages in accordance with an original presentation time of the video program event.

7. The method of claim 1, wherein the synchronizing step synchronizes the obtained social media messages in accordance with a local time zone.

8. A method of providing social media content in conjunction with the presentation of video content, the method comprising:
accessing a database of social media messages;
searching the database of social media messages to identify program-related social media messages that reference a video program event;
analyzing time stamp information of the program-related social media messages to identify time-related social media messages having message publication times that occurred during an original presentation of the video program event;
providing a time-delayed version of the video program event for presentation; and
delivering a synchronized stream of the time-related social media messages concurrently with presentation of the time-delayed version of the video program event, wherein timing of the synchronized stream is influenced by presentation timing of the time-delayed version of the video program event.

9. The method of claim 8, wherein:
the video program event is identified by a social media handle; and
searching the database of social media messages comprises searching for the social media handle.

10. The method of claim 9, wherein the social media handle comprises a hashtag of the video program event.

11. The method of claim 9, wherein the social media handle comprises an at-mention of the video program event.

12. The method of claim 8, wherein the timing of the synchronized stream is influenced by a local time zone in which the time-delayed version of the video program event is presented.

13. The method of claim 8, wherein the social media messages comprise a plurality of text messages.

14. A video presentation system comprising:
receiver interface to receive data associated with video services;
a display interface for a display operatively coupled to the video presentation system, the display interface facilitating presentation of content on the display; and
a processor coupled to the receiver interface and the display interface, wherein the processor cooperates with the receiver interface and the display interface to:
provide a time-delayed version of a video program event for presentation on the display; and
deliver a synchronized stream of time-delayed social media messages concurrently with presentation of the time-delayed version of the video program event, wherein each of the time-delayed social media messages identifies the video program event, and wherein timing of the synchronized stream is influenced by presentation timing of the time-delayed version of the video program event.

15. The video presentation system of claim 14, further comprising a database of social media messages, wherein the database includes each of the time-delayed social media messages.

16. The video presentation system of claim 14, wherein:
the video program event is identified by a social media handle; and
each of the time-delayed social media messages includes the social media handle of the video program event.

17. The video presentation system of claim 16, wherein the social media handle comprises a hashtag of the video program event.

18. The video presentation system of claim 16, wherein the social media handle comprises an at-mention of the video program event.

19. The video presentation system of claim 14, wherein:
each of the time-delayed social media messages includes respective time stamp information that indicates a message publication time; and
the synchronized stream is temporally aligned with the time-delayed video program event using the time stamp information.

20. The video presentation system of claim 14, wherein:
the time-delayed version of the video program event comprises a recorded version of an original presentation of the video program event; and
the recorded version of the original presentation of the video program event is provided by streaming to the video presentation system.
